(19) United States
(12) Patent Application Publication
(10) Pub. No.: US 2006/0111965 A1
(43) Pub. Date: May 25, 2006

(54) Methods and system for marketing a commitment symbol and related method for engendering community recognition of same

(75) Inventor: Robin Roshkind, West Palm Beach, FL (US)

Correspondence Address: AKERMAN SENTERFITT, P.O. BOX 3188, WEST PALM BEACH, FL, 33402-3188, US

(73) Assignee: COCO INDUSTRIES, INC., West Palm Beach, FL (US)

(21) Appl. No.: 11/286,822

(22) Filed: Nov. 23, 2005

Related U.S. Application Data
(60) Provisional application No. 60/630,940, filed on Nov. 24, 2004.

(51) Int. Cl. G06F 17/30

(52) U.S. Cl. 705/10

(57) ABSTRACT

A method of marketing a symbol of commitment is provided. The method includes identifying a symbol that can be recognized as a showing of a predetermined type of personal commitment. The also includes providing at least one design of the symbol. Additionally, the method includes determining at least one retail establishment for supplying such symbol to members of the community who wish to be recognized for having made the personal commitment. The method further includes conducting a knowledge-spreading campaign to inform would-be purchasers of the symbol of commitment.

### CROSS-REFERENCE TO RELATED APPLICATIONS

The utility patent application claims the priority of U.S. Provisional Patent Application No. 60/630,940 filed Nov. 24, 2005, and incorporated by reference herein in its entirety.

### FIELD OF THE INVENTION

The present invention is related to the field of articles recognized within a society as a symbol of personal commitment, and, more particularly, to methods of generating recognition among a significant portion of a community of a particular article's significance as a symbol of commitment.

### BACKGROUND OF THE INVENTION

Throughout most if not all of recorded history, personal commitment between members of a society has taken many different forms. Such commitments have traditionally been signified and celebrated by rituals preformed and/or articles worn as public affirmation of such a commitment. This remains true throughout the world today. One of the most enduring forms of commitment is the marriage of two people. The well-known rituals associated with marriage include the wedding ceremony and the publicly-declared period of engagement that precedes the wedding ceremony. Two of the most enduring and well-known symbols of personal commitment are also associated with marriage: the engagement ring and the wedding ring.

Traditionally, the engagement ring has taken the form of a diamond ring that is worn by the female partner of a different-sex couple to signify her impending marriage. The wedding ring, worn by both a husband and wife, has traditionally been a gold ring or wedding band.

More recently, other forms of social and personal commitment between two people have gained wider recognition within society. One form of commitment is that between a man and woman who, though not choosing to enter into a traditional marriage, live together and/or otherwise form a partnership based on personal commitment. Another form of commitment that, although slower in gaining acceptance among all sectors of society, is becoming more prevalent is that between two members of the same sex. As with other forms of non-traditional partnerships, same-sex couples often live together and/or pursue a lifestyle that is in many ways similar to a traditional marriage.

Although non-traditional unions are becoming more prevalent, the ceremonies and symbols of personal commitment are not as widely recognized as those associated with traditional unions. More particularly, there is no article worn by partners to a non-traditional different-sex or same-sex union that is recognized by a significant portion of the community as symbolizing the wearer's personal relationship or commitment.

One reason for this lack of a recognizable symbol of non-traditional commitment is the inherent time lag between when individuals adopt an article, such as a ring, for signifying their commitment and when the broader community comes to associate the article as a symbol of commitment. Accordingly, there is a need not only for an effective and efficient mechanism for identifying an article that will be accepted as a symbol of commitment, but as significantly, a need for a mechanism for fostering among the broader community a recognition that the identified article symbolizes a particular type of commitment.

### SUMMARY OF THE INVENTION

In view of the foregoing, it is an object of the present invention to provide a mechanism for engendering recognition of a symbol as signifying a commitment apart from traditional engagement or marriage. Accordingly, it is a further object of the invention to formulate a marketing campaign to draw recognition to a chosen symbol of commitment, the symbol being an article suitable to be worn by same-sex and/or different-sex couples as expression of mutual commitment. It is a further object of the present invention to foster an understanding of commitment throughout history.

According to one embodiment of the present invention a symbol of commitment is an emerald ring. The ring can be worn by both members of a couple interested in showing commitment to one another. Through an extensive knowledge-spreading campaign, the otherwise slow evolution by which significant members of a community come to associate the ring with a particular type of commitment can be accelerated.

Another embodiment of the invention is a method of marketing a symbol of commitment. The method can include identifying a symbol that can be recognized as a showing of a predetermined type of personal commitment. The method also can include providing at least one design of the symbol. Additionally, the method can include determining at least one retail establishment for supplying such symbol to members of the community who wish to be recognized for having made the personal commitment. The method further can include conducting a knowledge-spreading campaign to inform would-be purchasers of the symbol of commitment.

Still another embodiment of the invention is a method for engendering community recognition of a ring or other wearable article as a symbol of commitment. The method can include identifying a wearable article that can be recognized within a community as symbol of a pre-selected form of personal commitment by a wearer. The method also can include determining at least one retail establishment that can supply the wearable article to members of the community who wish to be recognized for having made the personal commitment. The method further can include launching a knowledge-spreading campaign to inform would-be purchasers of the symbol of commitment.

Yet another embodiment of the invention is a system for engendering community recognition of a wearable article as a symbol of commitment. The system can include a server that connects to a data communications network accessible to a plurality of hosts. The system further can include a processing module residing on the server for processing data exchanged via the data communications network with the plurality of hosts. The processing module can be configured to solicit survey data by sending data solicitations to the plurality of hosts requesting information concerning consumer interest in acquiring a wearable article to serve as a symbol of commitment; to identify targeted consumers based on survey data received from at least a portion of the plurality of hosts; and to determine geographic locations corresponding to the targeted consumers. The processing module also can be configured to identify at least one potential retail supplier of the wearable article in each geographic location, and to supply advertising data to the targeted consumers, the advertising data informing the targeted consumers about the wearable article. The processing module can be further configured to receive feedback data from the targeted consumers.

### BRIEF DESCRIPTION OF THE DRAWINGS

There are shown in the drawings, embodiments which are presently preferred. It is to be understood, however, that the invention is not limited to the precise arrangements and instrumentalities shown.

FIG. 1 is a perspective view of a gold band with emerald insert that, according to one embodiment of the invention, serves as a symbol of commitment.

FIG. 2 shows a side elevation view of the ring of FIG. 1;

FIG. 3 is a top view of the ring of FIG. 1.

FIG. 4 is a flowchart of the exemplary steps of a method for marketing a symbol of commitment, according to another embodiment of the invention.

FIG. 5 is a schematic diagram of a system for marketing a symbol of commitment, according to yet another embodiment of the invention.

### DETAILED DESCRIPTION

The present invention is directed to systems and related methods for engendering community recognition of a symbol of commitment. More particularly, the method aspects of the invention include a method of marketing a symbol of a non-traditional commitment that is different from that of engagement or marriage. The symbol can be, for example, a wearable article such as a ring that comes to symbolize the non-traditional nature of a particular type of personal or social commitment. By having a design different from those of engagement rings and wedding bands that have long been associated with more traditional unions, the ring can be readily recognized as signifying the non-traditional nature of the wearer's commitment to another individual.

The engendering of community recognition that a particular ring or other article symbolizes a particular type of commitment can normally be a slow, even haphazard process. This is because the association of a ring or other article with a particular type of personal commitment evolves over time in the minds of members of a particular community. As explained herein, the system and methods of the invention can accelerate this evolutionary process. More particularly, and as described in detail below, one aspect of the invention is an extensive knowledge-spreading campaign that can efficiently inform large numbers of people about the symbol and its availability. In a latter phase, the knowledge-spreading campaign can generate a bandwagon or network effect by informing other members of a community that the symbol has been adopted by some of its members as an indication of a particular type of commitment.

According to the network phenomenon described in economic theory, the value;of the symbol increases as more members of a community recognize the ring or other article as the preferred symbol of a particular type of commitment. As the value of the symbol increases, so too does demand for the symbol. This phenomenon is capitalized on through the knowledge-spreading campaign according to one embodiment of the invention. In particular, the campaign can provide testimonials, vignettes, and/or human interest stories through various media that attest to the adoption of the symbol by some members of a community. By spreading knowledge of the adoption, other members of the community are likely to follow suite and adopt the symbol as well. Thus, through this continuous information-feedback process, the otherwise slow evolutionary process of associating a ring or other article with commitment can be accelerated.

A preferred embodiment of the symbol, according to one embodiment of the invention, is an emerald ring. While many designs of emerald rings exist, such rings are enjoyed for their decorative affect and up to now have had no significance as a symbol of commitment. Nevertheless, emerald rings could serve as a serious symbol of commitment as they can be easily spotted and are rare enough, particularly as worn by men, to stand out and be noticeable as a symbol of commitment to be widely adopted by members of a community.

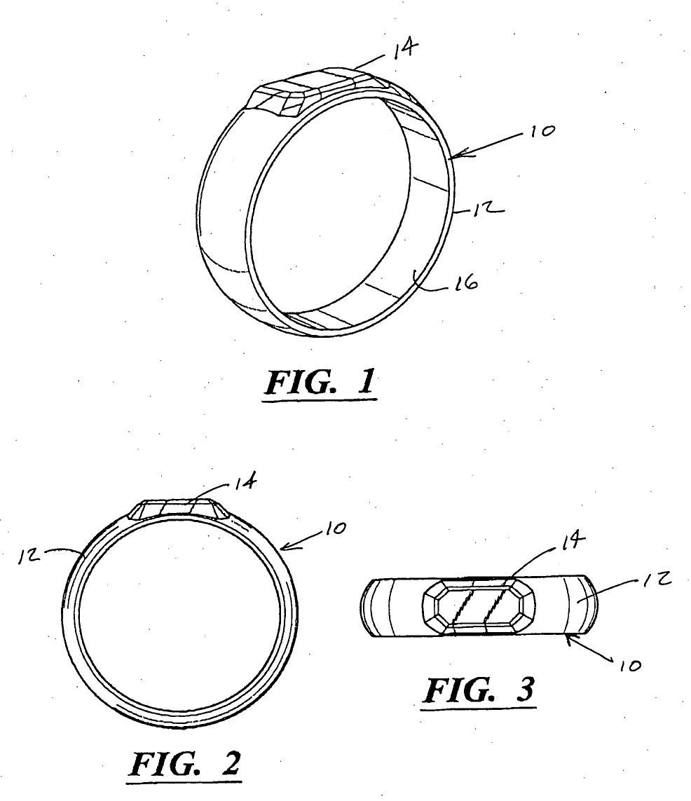

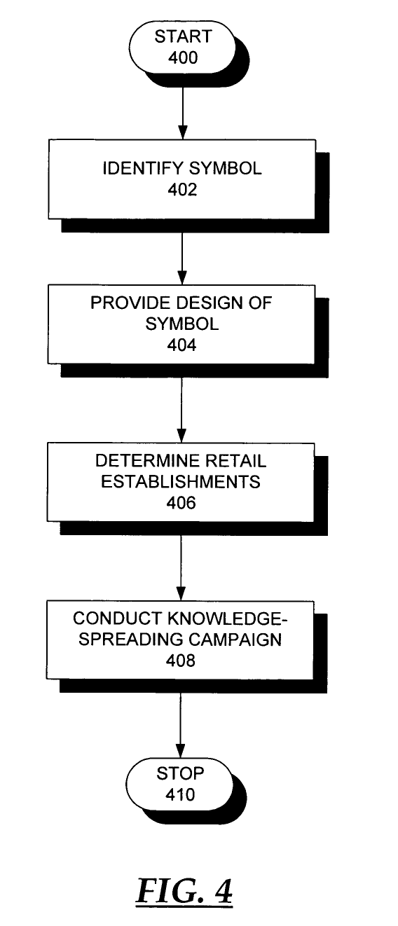

FIGS. 1-3 provide perspective views of an emerald ring 10, defining a commitment ring, which according to one embodiment of the invention serves as a symbol of commitment. The ring 10, as illustrated, comprises a gold band portion 12 and a stone insert 14 that for the purposes of the commitment ring is an emerald. The inner portion 16 of the ring is typically smooth and can be variable sized to fit the finger of any wearer.

The commitment ring 10 is but one of many different designs that can function as a symbol of commitment. The emerald stone 14 has been selected in the preferred embodiment because the emerald stone has particular visual impact when seen and is fairly unusual when placed in a gold band. Through a marketing plan, according to an additional aspect of the invention, can over time be associated in the minds of members of the community with a particular type of commitment made by its wearer. Accordingly, the commitment ring 10 can be recognized as the symbol of a particular type of commitment.

While it is contemplated that multiple designs of emerald rings can be recognized as a symbol of commitment, it can also be that only one design, perhaps with variations of the symbol, that will become particularly well known. Such symbol can be advertised and can simultaneously serve a dual purpose as a logo.

For the commitment ring 10, or indeed any other symbol of commitment, to be widely adopted and fairly quickly accepted as signifying a particular type of commitment, at least one retail establishment will carry such symbol and assist in promoting it as a symbol of commitment. Such a retail establishment may be a well-known jewelry store having a national presence associated with widely dispersed retail outlets. Alternatively, or additionally, the retail establishment can be a department store with a similar national presence. While the marketing plan may be directed to exclusive rights given to a single retail establishment, there can be an alternative arrangement by which non-exclusive retail licenses are granted to various different establishments. Further, with respect to exclusivity, a third embodiment can be directed to a combination of the above; that is, exclusive rights can be granted for a certain period of time, for example 3 or 5 years, followed by a period of non-exclusive rights granted to multiple entities as acceptance and popularity of the ring grows.

As part of the method of marketing a symbol of commitment, it is recognized that the history of commitment will be an important consideration. Through a marketing campaign, the opportunity to provide a historical basis for commitment can lend an educational purpose to the marketing of the commitment ring 10. It is to be noted that marketing of the commitment ring 10 can have particular significance to certain community members, including different-sex and same-sex couples. Previously, there has not been a widely recognized symbol by which same-sex couples can signify allegiance and commitment one to another.

FIG. 4 provides a flowchart of the exemplary steps of a method 400 of marketing a symbol of commitment. The method 400 illustratively includes, at step 402, identifying a symbol that can be recognized as a showing of a predetermined type of personal commitment. Additionally, the method 400 illustratively includes providing at least one design of the symbol at step 404. The method further illustratively includes, at step 406, determining at least one retail establishment for supplying such symbol to members of the community who wish to be recognized for having made the associated personal commitment. At step 408, the method 400 illustratively includes conducting a knowledge-spreading campaign to inform would-be purchasers of the symbol of commitment. The method 400 illustratively concludes at step 410.

The symbol of commitment identified at step 402 can be a ring, defining a commitment ring. The design of the commitment ring provided at step 404, moreover, can comprise a gold band and an emerald mounted to the gold band as described above.

The at least one retail establishment determined at step 406 can be a retail chain of jewelry stores. The retail chain of jewelry stores can, moreover, be characterized as having a regional presence within a predetermined geographic region by virtue of the chain operating multiple retail outlets dispersed throughout the region. Alternatively, the retail chain of jewelry stores can have a national presence established through multiple stores dispersed nationally. Alternatively, or additionally, the at least one retail establishment can be a chain of retail department stores. The chain or retail department stores likewise can have a particular regional presence or, according to an alternative embodiment, have a national presence.

According to one embodiment, the step 402 of identifying a symbol can comprise conducting one or more surveys to determine a symbol preference among consumers generally or among identified would-be purchasers specifically. In the latter case, more than one group of would-be purchasers can be surveyed.

The step 404 of providing at least one design of the symbol can comprise designing the symbol based on consumer survey information. The step 404 of providing at least one design of the symbol, moreover, can further include providing multiple designs of the symbol. Different designs can be selected, for example, by identifying—again, through consumer survey methods, for example—those designs that have appeal to at least a minimum number of would-be purchasers. The minimum number can be determined, for example, based on assessment of the marginal and/or average costs of production associated with different levels of production.

Additionally, the step of providing multiple designs of the symbol can be based upon feedback information provided by would-be purchasers of the symbol of commitment. Feedback information can be obtained, for example, through consumer surveys. Additionally, or alternatively, feedback information can be obtained by establishing an Internet web site accessible to would-be purchasers who can provide feedback information by logging on to the web site.

The step 406 of determining at least one retail establishment can comprise determining at least one geographic region populated by would-be purchasers of the symbol. More particularly, the step 406 can be performed by identifying regions having a population size of would-be purchasers that exceeds a predetermined population threshold. For each region so identified, the step 406 can further include determining at least one regional retail establishment that is capable of supplying the symbol to would-be purchasers. As will be readily appreciated by those of ordinary skill in the art, if more than one capable supplier is identified, a particular supplier or suppliers can be chosen on the basis of cost. Specifically, a supplier or suppliers can be selected based on whether or not the cost of distributing through a particular supplier is equal to or less than a predetermined cost threshold.

The optional step of determining at least one geographic region associated with a particular supplier or suppliers, moreover, can include determining the population size of would-be purchasers based on a regional-based consumer survey. Such surveys can be conducted through a data communications network, print medium, radio medium, and/or television medium, as will be readily understood by one of ordinary skill in the art.

The step 408 of conducting a knowledge-spreading campaign can include disseminating knowledge of the history of commitment through advertisements and/or public messages. Such advertisements and messages also can be transmitted via one or more data communications networks as well as a print medium, radio medium, and/or television medium. The dissemination of knowledge about the history of commitment can serve not only a marketing purpose but also a public purpose. The marketing purpose is served because knowledge of the history can foster consumer identification with the symbol, stimulating demand among would-be purchasers. The public purpose can be served because the knowledge can promote better understanding of different forms of commitment among the broader community.

According to a particular embodiment, the step 408 of conducting a knowledge-spreading campaign can comprise distinct phases. The distinct phases can be timed so that the efforts undertaken during each phase support those undertaken during the other phases.

A possible first phase of the knowledge-spreading campaign taken at 408 can identify would-be purchasers. The identification, of course, can be based on consumer surveys. The consumer surveys can be conducted via a data communications network, print medium, radio medium, and/or television medium.

Additionally, a possible second phase of the knowledge-spreading campaign take at step 408 can inform would-be purchasers about one or more retail establishments through which the symbol can be obtained. The information also can be disseminated to would-be purchasers through a data communications network, print medium, radio medium, and/or television medium.

A third phase of the knowledge-spreading campaign taken at step 408 can generate a network effect by disseminating to other would-be purchasers information about actual purchasers of the symbol. The information can comprise, for example, testimonials of actual purchasers that demonstrate the emotional benefit the purchasers have obtained by being able to express their commitment through the symbol. The information additionally, or alternatively, can comprise reports of adoptions of the symbol as an indication of commitment among members of a particular community. Such information can be provided by selecting news accounts and human-interest stories that may already have been published in various media.

As described, the various embodiments of methods for marketing a symbol of commitment and engendering recognition of the significance of the symbol within the community can utilize various mediums. For example, information can be conveyed, as well as obtained, via a data communications network as well as through more conventional media such as print, radio, and television. Another aspect of the invention, however, is a data-communications-network-based system. The system provides additional opportunities for effectively and efficiently marketing a symbol of commitment and engendering community recognition of its significance.

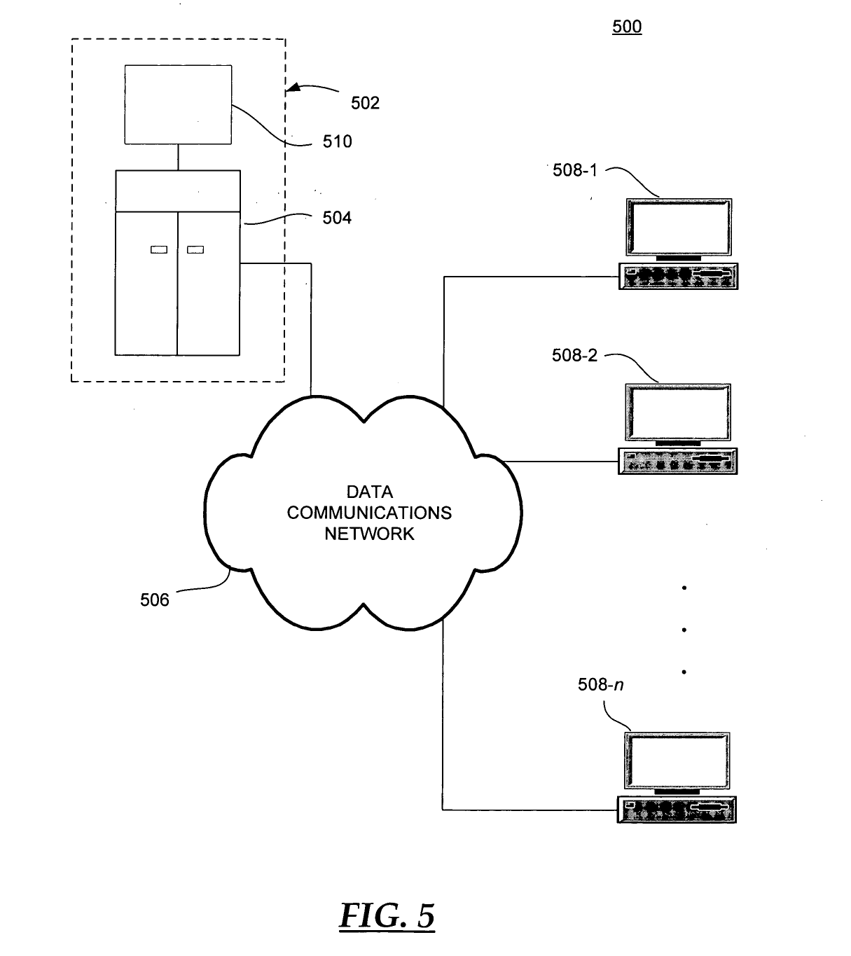

FIG. 5 provides a schematic diagram of a communications environment 500 that includes a system 502 for engendering community recognition of a wearable article as a symbol of commitment, according to another embodiment of the invention. The system 502 illustratively includes a server 504 that connects to a data communications network 506 that is accessible to a plurality of hosts 508-1, 508-2, 508-n. The system 502 further illustratively includes a processing module 510 residing on the server 504. As will be readily understood by one of ordinary skill in the art, the processing module 510 can comprise dedicated hardwired circuitry and/or software code configured to run on an application-specific computing device, such as a server, or on a general-purpose computing device.

The processing module 510 is illustratively configured to process data exchanged via the data communications network 506 with the plurality of hosts 508-1, 508-2, 508-n. According to one embodiment, the processing module 510 is configured to solicit survey data by sending data solicitations to the plurality of hosts 508-1, 508-2, 508-n. The solicitations can be made by requesting information concerning consumer interest in acquiring a wearable article to serve as a symbol of commitment. Through the solicitations the processing module 510 can identify targeted consumers based on survey data received from at least a portion of the plurality of hosts 508-1, 508-2, 508-n. Additionally, the processing module 510 is illustratively configured to determine geographic locations corresponding to the targeted consumers, the determination being based on responses to the solicitations conveyed via the data communications network 506.

The processing module 510 is also illustratively configured to identify at least one potential retail supplier of the wearable article in each geographic location identified. Additionally, the processing module 510 is illustratively configured to supply advertising data to the targeted consumers via the data communications network 506, the advertising data informing the targeted consumers about the wearable article and its availability for purchase at one or more retail establishments. Optionally, the processing module 510 can be further configured to receive feedback data from the targeted consumers.

The system 502, according to another embodiment, can also include a memory (not shown) residing on the server 504 or otherwise communicatively linked to the server from a remote site. The memory can contain data, defining an information database that comprises feedback data supplied via the data communications network 506. The feedback data can provide information relating to expressed attitudes and personal experiences of couples who have adopted the wearable article as a symbol of their commitment to one another. The processing module 510, moreover, can be configured to provide the plurality of hosts 508-1, 508-2, 508-n access to the information database via the data communications network 506. Making the database accessible to would-be purchasers can generate the network effect, described above, causing the subjective value of the wearable article to increase among would-be purchasers who learn that other similarly-situated couples have adopted the wearable article has an expression of their commitment.

The survey data processed by the processing module 5.10 can comprise one or more questions about a respondent's lifestyle and attitudes toward different pre-selected forms of commitment. Based on the responses to such questions, the processing module 510, when configured to process the responses, can identify targeted consumers. More particularly, the processing performed by the processing module 510 can entail application of various known statistical survey algorithms so as to target potential would-be purchasers among the broader consumer population.

The processing module 510, according to yet another embodiment, can be further configured to provide via the data communications network 506 offers to supply the wearable article. The offers, more particularly, can be directed to different potential retail suppliers identified according to various methods, including those described herein. Accordingly, one or more potential retail suppliers can be identified according to geographical region and/or other economics-based criterion.

The processing module 510, according to still another embodiment, can be further configured to provide via the data communications network 506 promotional data to would-be purchasers. The promotional data or information can, for example, provide indications of the acceptance of the wearable article as a symbol of commitment among a significant portion of a community in a geographical region. The information conveyed, for example, can include testimonials of couples who have adopted the wearable article as an expression and symbol of their commitment. Alternatively, or additionally, the information conveyed can comprise reports on couples who have adopted the wearable article as a symbol of commitment, the reports be culled from news organizations, for example, or other sources of human-interest stories.

As described herein, the invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

I claim:

1. A method of marketing a symbol of commitment, the method comprising:
identifying a symbol that can be recognized as a showing of a predetermined type of personal commitment;
providing at least one design of the symbol;
determining at least one retail establishment for supplying such symbol to members of the community who wish to be recognized for having made the personal commitment; and
conducting a knowledge-spreading campaign to inform would-be purchasers of the symbol of commitment.

2. The method of claim 1, wherein the symbol of commitment is a ring comprising a gold band and an emerald mounted to the gold band.

3. The method of claim 1, wherein the at least one retail establishment is a retail chain of jewelry stores.

4. The method of claim 1, wherein the at least one retail establishment is a chain of retail department stores.

5. The method of claim 1, wherein the step of identifying a symbol includes conducting at least one survey to determine a symbol preference among at least one identified group of would-be purchasers.

6. The method of claim 1, wherein the step of providing at least one design of the symbol comprises designing the symbol based on consumer survey information.

7. The method of claim 1, wherein the step of providing at least one design of the symbol further includes providing multiple designs of the symbol.

8. The method of claim 7, wherein the step of providing multiple designs of the symbol is based upon feedback information provided by would-be purchasers of the symbol of commitment.

9. The method of claim 1, wherein the step of determining at least one retail establishment comprises:
determining at least one geographic region populated by would-be purchasers of the symbol, wherein a population size of would-be purchasers exceeds a predetermined population threshold; and
determining at least one regional retail establishment in each at least one geographic region, wherein each at least one retail establishment per geographic region is capable of supplying the symbol to would-be purchasers at a cost equal to or less than a predetermined cost threshold.

10. The method of claim 9, wherein the step of determining at least one geographic region comprises determining the population size of would-be purchasers based on a regional-based consumer survey conducted through at least one of a data communications network, print medium, radio medium, and television medium.

11. The method of claim 1, wherein the step of conducting a knowledge-spreading campaign includes the further step of disseminating knowledge of the history of commitment through advertisements and public messages transmitted via at least one of a data communications network, print medium, radio medium, and television medium.

12. The method of claim 1, wherein the step of conducting a knowledge-spreading campaign comprises:
a first phase of identifying would-be purchasers based on consumer surveys conducted via at least one of a data communications network, print medium, radio medium, and television;
a second phase of informing would-be purchasers of the at least one retail establishment where the symbol can be obtained; and
a third phase of generating a network effect by disseminating to other would-be purchasers information of actual purchasers of the symbol, the information comprising at least one of testimonials of actual purchasers and reports of adoptions of the symbol as an indication of commitment among members of predetermined community.

13. A method of for engendering community recognition of a wearable article as a symbol of commitment, the method comprising:
identifying a wearable article that can be recognized within a community as symbol of a pre-selected form of personal commitment by a wearer;
determining at least one retail establishment that can supply the wearable article to members of the community who wish to be recognized for having made the personal commitment; and
launching a knowledge-spreading campaign to inform would-be purchasers of the symbol of commitment.

14. The method of claim 13, wherein the step of identifying comprises conducting at least one survey to determine a preference among at least one identified group of would-be purchasers for a particular wearable article.

15. The method of 13, wherein the step of determining at least one retail establishment comprises:
determining at least one geographic region populated by would-be purchasers of the wearable article, wherein a population size of would-be purchasers exceeds a predetermined population threshold;
determining at least one regional retail establishment in each at least one geographic region, wherein each at least one retail establishment per geographic region is capable of supplying the symbol to would-be purchasers at a cost equal to or less than a predetermined cost threshold.

16. The method of claim 15, wherein the step of determining at least one geographic region comprises determining the population size of would-be purchasers based on a regional-based consumer survey conducted through at least one of a data communications network, print medium, radio medium, and television medium.

17. The method of claim 13, wherein the step of conducting a knowledge-spreading campaign includes the further step of disseminating knowledge of the history of commitment through advertisements and public messages transmitted via at least one of a data communications network, print medium, radio medium, and television medium.

18. The method of claim 13, wherein the step of conducting a knowledge-spreading campaign comprises:
a first phase of identifying would-be purchasers based on consumer surveys conducted via at least one of a data communications network, print medium, radio medium, and television;
a second phase of informing would-be purchasers of the at least one retail establishment where the symbol can be obtained; and
a third phase of generating a network effect by disseminating to other would-be purchasers information of actual purchasers of the symbol the information comprising at least one of testimonials of actual purchasers and reports of adoptions of the symbol as an indication of commitment among members of predetermined community

19. A system for engendering community recognition of a wearable article as a symbol of commitment, the system comprising:
a server that connects to a data communications network accessible to a plurality of hosts; and
a processing module residing on the server for processing data exchanged via the data communications network with the plurality of hosts, the processing module being configured to:
solicit survey data by sending data solicitations to the plurality of hosts requesting information concerning consumer interest in acquiring a wearable article to serve as a symbol of commitment, identify targeted consumers based on survey data received from at least a portion of the plurality of hosts, and determine geographic locations corresponding to the targeted consumers;
identify at least one potential retail supplier of the wearable article in each geographic location;
supply advertising data to the targeted consumers, the advertising data informing the targeted consumers about the wearable article; and
receive feedback data from the targeted consumers.

20. The system of claim 19, further comprising a memory communicatively linked to the processing module and defining an information database containing data based on the feedback data, the feedback data providing information relating to expressed attitudes and personal experiences of couples who have adopted the wearable article as a symbol of their commitment to one another.

21. The system of claim 20, wherein the processing module is further configured to provide the plurality of hosts access to the information database via the data communications network.

22. The system of claim 19, wherein the survey data comprises a plurality of questions about respondents lifestyles and attitudes toward different pre-selected forms of commitment.

23. The system of claim 22, wherein the processing module is configured to identify targeted consumers by applying a statistical survey algorithm to answers supplied to the plurality of questions.

24. The system of claim 19, wherein the processing module is further configured to provide via the data communications network offers to supply the wearable article to different potential retail suppliers in different geographical regions.

25. The system of claim 24, wherein the processing module is further configured to provide via the data communications network promotional data indicating acceptance of the wearable article as a symbol of commitment among a significant portion of a community in a geographical region.
